(19) United States
(12) Patent Application Publication
(10) Pub. No.: US 2025/0144455 A1
(43) Pub. Date: May 8, 2025

(54) AIRCRAFT MAINTENANCE FALL PROTECTION

(71) Applicant: The Boeing Corporation, Arlington, VA (US)

(72) Inventors: Michael J. DeLuca, Norristown, PA (US); Kelli Barbato, Bath, PA (US); Satyaki Bhowmik, Brisbane (AU); Benedict Hardless, Toowoomba (AU)

(21) Appl. No.: 18/503,888

(22) Filed: Nov. 7, 2023

(51) Int. Cl. A62B 35/00; B64C 27/00

(52) U.S. Cl. CPC A62B 35/0068; A62B 35/0056; B64C 27/32; B64F 5/40

(57) ABSTRACT

Systems, apparatus, articles of manufacture, and methods are disclosed for aircraft maintenance fall protection. An example aircraft maintenance fall protection system includes an anchor couplable to a rotor shaft of an aircraft, the anchor including a flyable fitting configured to be coupled to the rotor shaft during flight and an extension fitting assembly removably couplable to the flyable fitting, the extension fitting assembly to support a tether for a maintenance operator.

### GOVERNMENT LICENSE RIGHTS

This invention was made with Government support under (WA-22-05577) awarded by (Department of Defense). The government has certain rights in the invention.

### FIELD OF THE DISCLOSURE

This disclosure relates generally to aircraft maintenance and, more particularly, to aircraft maintenance fall protection.

### BACKGROUND

Aircraft maintenance includes routine service and safety inspections. In some maintenance procedures, maintenance operators are positioned on top of the aircraft including the fuselage crown. The fuselage crown may be many feet above the ground. There are safety risks to the maintenance operators if the maintenance operators were to fall from the aircraft during the maintenance procedure.

### BRIEF DESCRIPTION OF THE DRAWINGS

FIG. 1 is an illustration of an example aircraft with an example aircraft maintenance fall protection system in accordance with the teachings of this disclosure.

FIG. 2A is a perspective view of an example rotor hub of the aircraft of FIG. 1.

FIG. 2B is a perspective view of an example flyable fitting.

FIG. 2C is a side view of the flyable fitting of FIG. 2B.

FIG. 2D is a perspective view of the rotor hub of FIG. 2A with the flyable fitting of FIG. 2B coupled thereto.

FIG. 2E is a perspective view of an example flyable fitting cover.

FIG. 2F is a side view of the flyable fitting cover of FIG. 2E.

FIG. 2G is a perspective view of the rotor hub of FIG. 2A with the flyable fitting of FIG. 2B and flyable fitting cover of FIG. 2E coupled thereto.

FIG. 2H is a cross-sectional view of the rotor hub of FIG. 2G taken along the 2H-2H line.

FIG. 3A is an exploded view of an example extension fitting assembly.

FIG. 3B is a cross-sectional view of the assembled extension fitting assembly of FIG. 3A in an assembled configuration showing a variable length.

FIG. 3C illustrates an example locking pin.

FIG. 3D is a cross-sectional view of a portion of the extension fitting assembly of FIG. 3B coupled with the flyable fitting of FIG. 2B.

FIG. 3E illustrates the extension fitting assembly of FIG. 3B assembled with the aircraft of FIG. 1.

In general, the same reference numbers will be used throughout the drawing(s) and accompanying written description to refer to the same or like parts. The figures are not necessarily to scale.

### DETAILED DESCRIPTION

Disclosed herein are aircraft maintenance fall protection systems to enhance the safety of maintenance operators during inspection of aircraft when access to the aircraft is not provided via ground support equipment or service stands. Some aircraft such as, for example, the H-47 Chinook helicopter have a fuselage crown that is approximately ten feet from the ground. A fall from this height to the ground could produce serious or fatal injuries. Examples disclosed herein include new attachment points provided on the aircraft for interfacing with the example aircraft maintenance fall protection systems disclosed herein. In some examples, the attachment points are at or near the fuselage crown, and the aircraft maintenance fall protection system includes a static line such as a rope extending between the two attachment points to which maintenance operators can attach via, for example, a harness and lanyard. The disclosed maintenance fall protection system is an unpowered, passive system that is easily installed. Maintenance operators can remain tethered to the maintenance fall protection system hands-free while they move about the crown of the aircraft. Maintenance operators do not need to detach and reattach to the maintenance fall protection system as they move about the aircraft.

In some examples disclosed herein the attachment points are at the forward and aft rotor shafts. These rotor shafts are fabricated from a gear steel that is sized to carry flight loads from the entire rotor system. As a result, the load paths are very robust and allow the aircraft maintenance fall protection system to support and absorb the energy to arrest two simultaneous falls (i.e., two maintenance operators falling at the same time). Also, in some examples, free fall distance is limited to 6.5 feet or less before the falls are arrested.

Example aircraft maintenance fall protection systems disclosed herein can be installed in less than five minutes without the use of tools. Maintenance operators can install the aircraft maintenance fall protection systems including attachment and detachment of the tether of their harnesses to the static line (i.e., the rope) while wearing personal protective equipment. Example aircraft maintenance fall protection systems disclosed herein also can be dismantled and stored as a kit in a single bag for transport with the aircraft.

In example aircraft maintenance fall protection systems disclosed herein, the maintenance operators are coupled to the static line via their harnesses and lanyard and, therefore, they are not required to hold onto grips on the fuselage and their hands remain free for other tasks.

Example aircraft maintenance fall protection systems disclosed herein also enable the rotation of the forward and aft rotor hubs with the blades installed throughout their entire range of motion during a maintenance operation without interference from the aircraft maintenance fall protection systems.

While examples disclosed herein are detailed with respect to a helicopter with a tandem rotor setup, example aircraft maintenance fall protection systems disclosed herein also may be adapted to interface with other aircraft. For example, one anchor point may be located on a main rotor hub and the other located at a tail boom, wing, ground support location, etc. In such examples, maintenance personnel coupled to the aircraft maintenance fall protection system still have full range of motion and ability to traverse across the entire aircraft. In addition, examples disclosed herein also may be used to increase safety during flight testing operations of experimental and/or production aircraft.

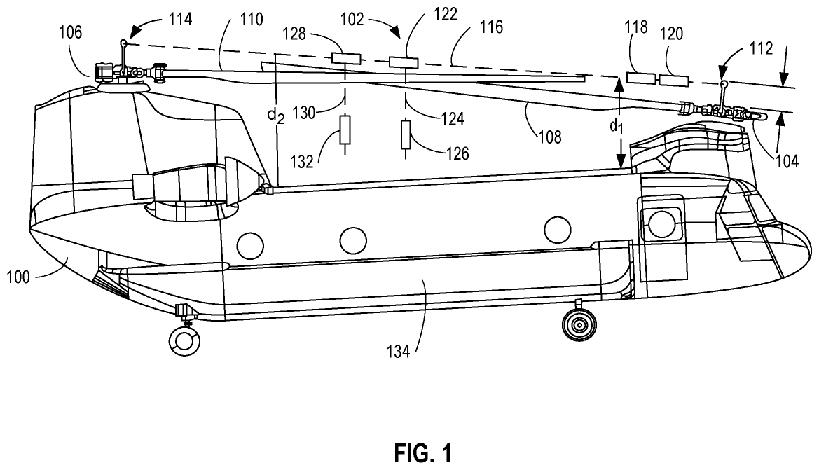

FIG. 1 is an illustration of an example aircraft 100 with an example aircraft maintenance fall protection system 102 in accordance with the teachings of this disclosure. The aircraft 100 includes an example first rotor hub 104 and an example second rotor hub 106. In this example, the first rotor hub 104 is a forward rotor hub, and the second rotor hub 106 is an aft rotor hub. An example first plurality of blades 108 are coupled to the first rotor hub 104. An example second plurality of blades 110 are coupled to the second rotor hub 106.

The aircraft maintenance fall protection system 102 includes an example first anchor 112 coupled to the first rotor hub 104 and example second anchor 114 coupled to the second rotor hub 106. An example static line 116 extends between the first anchor 112 and the second anchor 114. In some examples, the static line 116 is a rope such as, for example, a braided rope or a cable such as, for example, a stainless steel cable.

An example tensioner 118 can be used to adjust slack in the static line 116. In some examples, the tensioner 118 is a rachet-style tensioner. In some examples, a winch may be used for the tensioner 118. The aircraft maintenance fall protection system 102 also include an example in-line load cell 120. The load cell 120 includes a display to present an amount of tension in the static line 116. The maintenance operator can use the tensioner 118 to adjust tension in the static line 116 based on the amount of tension displayed on the load cell 120. In some examples, the maintenance operator adjusts the tension of the static line 116 to have several hundred pounds of force.

The aircraft maintenance fall protection system 102 also include a first pulley 122, a first lanyard 124, and a first energy absorber 126 to which a first maintenance operator can attach a first harness to couple to the aircraft maintenance fall protection system 102. In some examples, the aircraft maintenance fall protection system 102 includes a second pulley 128, a second lanyard 130, and a second energy absorber 132 to which a second maintenance operator can attach a second harness to couple to the aircraft maintenance fall protection system 102. In some examples, the first lanyard 124, the first energy absorber 126, the second lanyard 130, and/or the second energy absorber 132 are provided by or sourced from third parties and usable with the aircraft maintenance fall protection system 102.

In some examples, the first pulley 122 and/or second pulley 128 are movable pulleys that respectively include one or more wheels with a grooved rim or sheave to receive the static line 116. In some examples, the first lanyard 124 and/or the second lanyard 130 are coupled to respective ones of the first pulley 112 and/or the second pulley 128 via a mechanical fastener such as, for example, a carabiner.

In some examples, the first energy absorber 126 and/or the second energy absorber 132 are made of flat, loosely woven webbing. During a fall, this webbing stretches on impact to decelerate the motion of the maintenance operator. The elasticity of this material also helps eliminate the amount of force experienced by the maintenance operator. In some examples, the first energy absorber 126 and/or the second energy absorber 132 are made of a length of webbing that is folded, sewn together, and stored in an expansion pack. During a fall, the force of the weight of the maintenance operator acting on this section tears the attached segments away from each other. This absorbs energy created by the motion, decelerates the fall, and decreases the force experienced by the maintenance operator. In some examples, the first energy absorber 126 and/or the second energy absorber 132 are made of elastic material that expands and contracts based on movement of the maintenance operator. The elastic material absorbs energy to decelerate the maintenance operator during a fall. In some examples, the first energy absorber 126 and/or the second energy absorber 132 are integral with and/or partially coextensive with the respective first lanyard 124 and second lanyard 130.

In the example aircraft 100, the first rotor hub 104 is positioned a first distance or height above a main fuselage 134 of the aircraft 100, and the second rotor hub 106 is positioned a second distance or height above the main fuselage 134. The second distance is greater than the first distance. The static line 116, therefore, is positioned a first distance, d1, above the main fuselage 134 toward the forward part of the aircraft 100. The static line 116 is positioned a second distance, d2, above the main fuselage 134 toward the aft part of the aircraft 100. In some examples, d1 is greater than 6.5 feet and d2 is greater than 9.25 feet. In this example, the first plurality of blades 108 and the second plurality of blades 110 are rotatable under the static line 116. Thus, maintenance operators do not need to detach from the static line 116 during maintenance operations involving rotation of the blades 108, 110.

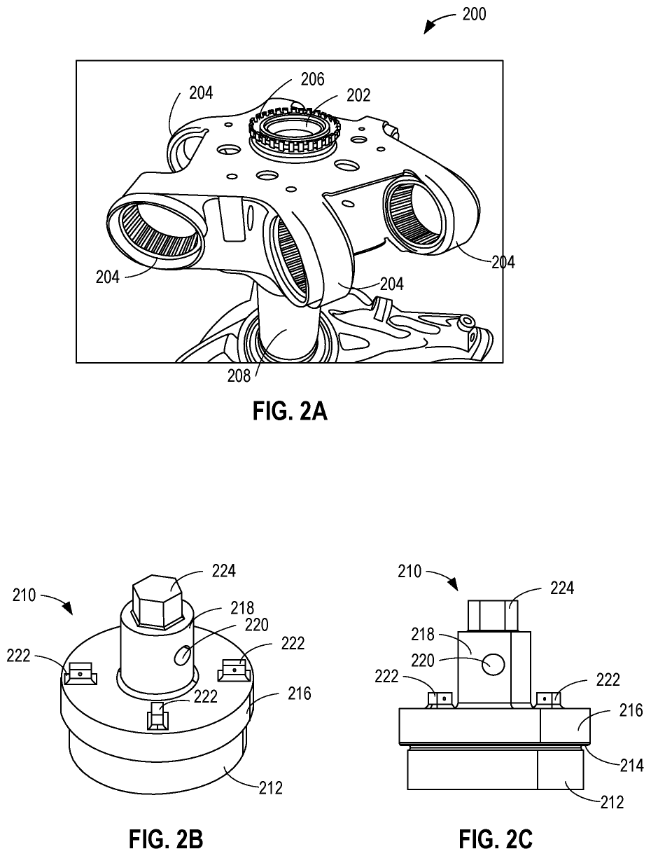

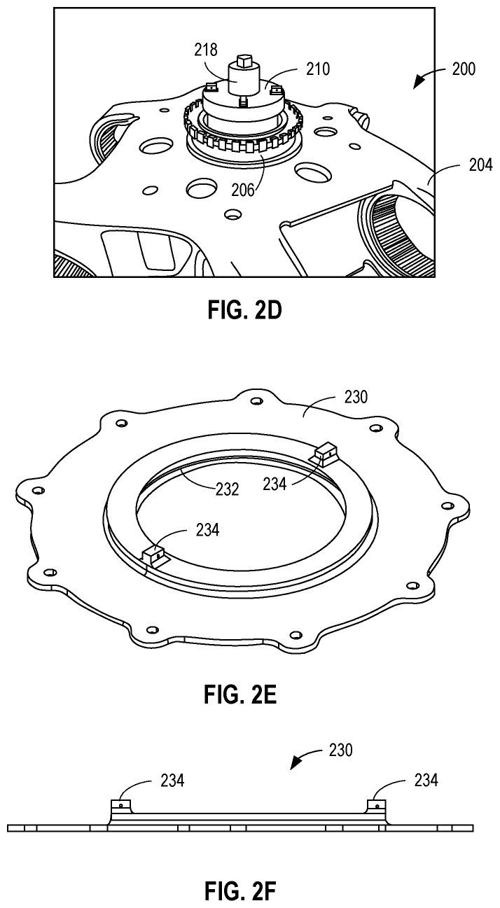

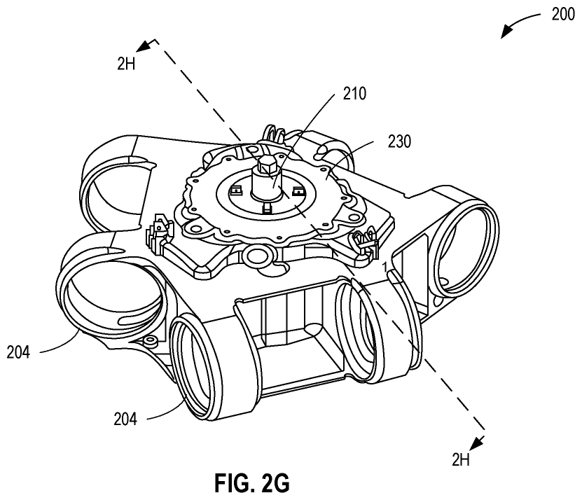

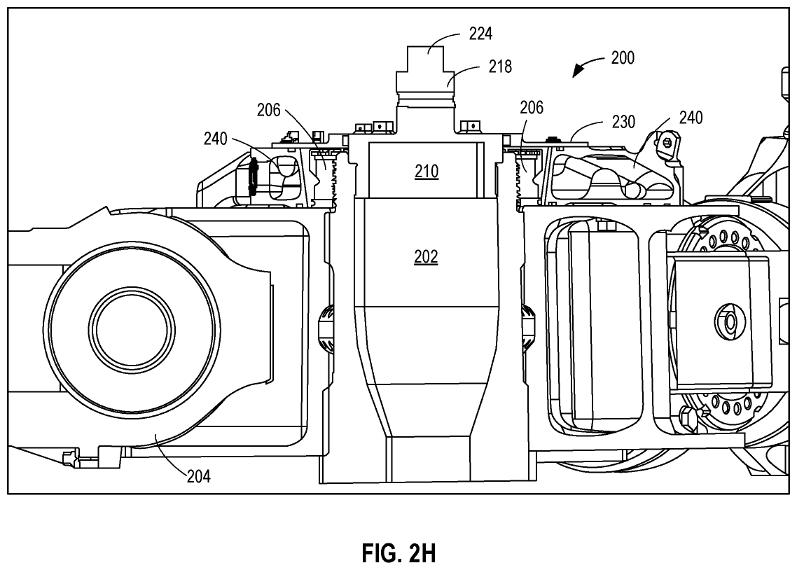

FIG. 2A is a perspective view of an example rotor hub 200 that can be the first rotator hub 104 or the second rotor 106 of the aircraft 100 of FIG. 1. The rotor hub 200 includes an example rotor shaft 202 above which the rotor hub rotates. The rotor hub also includes a plurality of arms 204 to which blades (e.g., the first plurality of blades 108 and/or the second plurality of blades 110) are coupled to the rotor hub 200. The rotor hub 200 also includes an example main rotor retaining nut 206. The main rotor retaining nut 206 holds the rotor hub 200 to a mast 208 of the aircraft 100.

FIG. 2B is a perspective view of an example flyable fitting 210. The flyable fitting 210 forms part of the first anchor 112 and the second anchor 114. That is, each of the first anchor 112 and the second anchor 114 include a flyable fitting 210. FIG. 2C is a side view of the flyable fitting 210. The flyable fitting 210 includes an example base 212, an example undercut 214, an example support flange 216, an example spigot 218, an example aperture 220, example lockwire flanges 222, and an example installation head 224.

The base 212 interfaces with the rotor shaft 202. In some examples the base 212 is threaded to the rotor shaft 202. The undercut 214 helps position the base 212 in the rotor shaft 202, and the support flange 216 supports and stabilizes the flyable fitting 210 on the rotor hub 200. A tool such as, for example, a wrench may be used to engage the installation head 224 to position the flyable fitting 210 in the rotor shaft 202. The example installation head 224 is a hex head but other configurations can be used. One or more lockwires may be threaded or weaved through the lockwire flanges 222 to mechanically secure the flyable fitting 210 and prevent rotation and loosening of the coupling between the flyable fitting 210 and the rotor hub 200. The spigot 218 and the aperture 220 are used to coupled additional components of the first anchor 112 and/or the second anchor 114, as disclosed herein.

FIG. 2D is a perspective view of the rotor hub 200 with the flyable fitting 210 coupled thereto. In some examples, the flyable fitting 210 is coupled into the rotor shaft 202 with a torque of up to 500-600 foot-pounds. The flyable fitting 210 can remain installed in the rotor shaft 202 during flight of the aircraft 100. The flyable fitting 210 does not alter load paths or generate any new ones. Thus, installation of the flyable fitting 210 does not affect flight performance of the aircraft 100.

FIG. 2E is a perspective view of an example flyable fitting cover 230. FIG. 2F is a side view of the flyable fitting cover 230. The flyable fitting cover 230 includes an example O-ring groove 232 and example lockwire flanges 234. In some examples, the flyable fitting cover 230 replaces a hub oil tank cover. The flyable fitting cover 230 interfaces with existing fastener holes for the hub oil tank cover. An O-ring may be positioned in the O-ring groove 232 to seal the hub oil tank. One or more the lockwires that are threaded through the lockwire flanges 222 of the flyable fitting 210 may be threaded or weaved through the lockwire flanges 234 of the flyable fitting cover 230 to mechanically secure the flyable fitting 210 and flyable fitting cover 230. Like the flyable fitting 210, the flyable fitting cover 230 is a flyable component that can remain on the aircraft 100 during flight.

FIG. 2G is a perspective view of the rotor hub 200 with the flyable fitting 210 and the flyable fitting cover 230 coupled thereto. FIG. 2H is a cross-sectional view of the rotor hub of FIG. 2G taken along the 2H-2H line. The flyable fitting 210 is positioned within the rotor shaft 202 concentric to the main rotor retaining nut 206. The mechanical connection between the rotor shaft 202 and the main rotor retaining nut 206 is unaffected by the addition of the flyable fitting 210.

The flyable fitting 210 also is positioned concentric to one or more oil reservoirs 240. The oil reservoirs 240 include oil to lubricate components of the rotor hub 200.

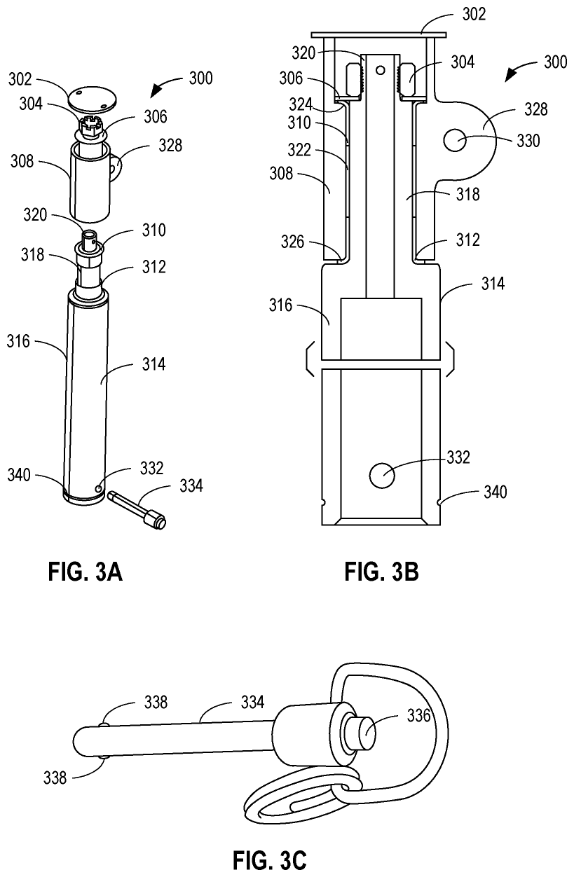

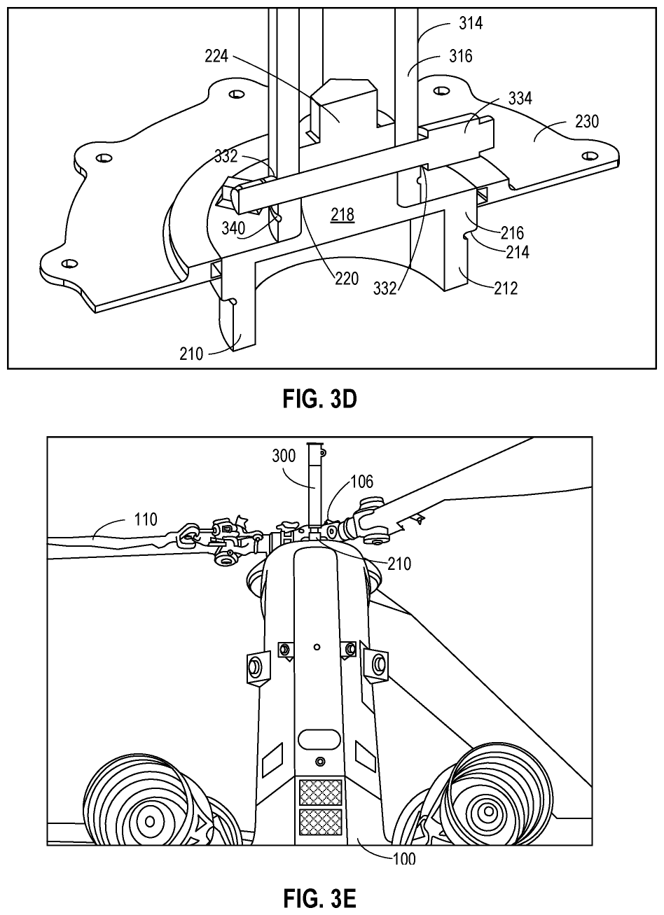

FIG. 3A is an exploded view of an example extension fitting assembly 300. FIG. 3B is a cross-sectional view of the extension fitting assembly 300 in an assembled configuration. The extension fitting assembly 300 forms part of the first anchor 112 and the second anchor 114. The extension fitting assembly 300 removably couplable to the flyable fitting 210 as disclosed herein. The brackets in FIG. 3B indicate that the length of the extension fitting assembly 300 may be different than shown in other examples.

The extension fitting assembly 300 includes an example dust cap 302, an example nut 304, an example washer 306, an example anchorage fitting 308, an example first flange bushing 310, an example second flange bushing 312, and an example extension pipe 314. The extension pipe 314 includes an example lower portion 316, an example intermediate portion 318, and an example upper portion 320. In some examples, the upper portion 320 has a diameter less than the diameter of the intermediate portion 318. In some examples, the intermediate portion 318 has a diameter less than the lower portion 316.

In the assembled configuration, a second flanged bushing 312 is positioned around a lower end of the intermediate portion 318 of the extension pipe 314. The anchorage fitting 308 is positioned around the second flanged bushing 312 and the intermediate portion 318. The first flanged bushing is positioned around an upper end of the intermediate portion 318 between the intermediate portion 318 and the anchorage fitting 308. The anchorage fitting 308 has a portion with an enlarged thickness that forms an engagement surface 322 with the first flanged bushing 310 and the second flanged bushing 312. A first flange 324 of the first flanged busing 310 extends around a first end of the engagement surface 322, and a second flange 326 of the second flanged busing extends around a second end of the engagement surface 322.

The washer 304 is positioned around the upper portion 320 of the extension pipe 314. The nut 304 is secured around the upper portion 320 of the extension pipe 314. In the illustrated example, the nut 304 is a hex nut. In other examples, other fasteners may be used. In the illustrated example, the upper portion 320 of the extension pipe 314 includes threads to complement the threads of the nut 304. The nut 304 maintains the vertical position and alignment of the first flange bushing 310, the second flange bushing 312, and the anchorage fitting 308. The intermediate portion 318 and the upper portion 320 of the extension pipe 314 form a mounting boss for the anchorage fitting 308. The dust cap 302 is fastened to the anchorage fitting 308 via a one or more fasteners such as, for example, screws.

In some example, the anchorage fitting 308 is rotatable about the extension pipe 314. In some examples, a lubricant may be included to facilitate rotational movement between the engagement surface 320 of the anchorage fitting 308 and the first flange bushing 310 and the second flange bushing 312. In other examples, the anchorage fitting 308 is not rotatable about the extension pipe 314.

The anchorage fitting 308 includes an example lug 328, which has an example aperture 330. The static line 116 is couplable to the anchorage fitting 308 via the lug 328. For example, a fastener such as, for example, a carabiner can be used to connect the static line 116 to the lug 328 via the aperture 330. If the anchorage fitting 308 is rotatable about the extension pipe 314, the position of the lug 328 can be adjusted by rotating the anchorage fitting 308 to align the static line 116 in a desired position without changing the position of the first anchor 112 and the second anchor 114 or components thereof.

The lower portion 316 of the extension pipe 314 includes an aperture 332 that extends through the extension pipe 314, so there is a corresponding aperture 332 on the other side across the diameter of the extension pipe 314 (FIG. 3D). An example locking pin 334 is removably receivable in the aperture 332. FIG. 3C illustrates the example locking pin 334, which in this example is a self-locking pin. The locking pin 334 includes a release button 336 that is pressed to retract tabs 338. The locking pin 334 includes internal biasing members that bias the tabs 338 to the extended position. When extended, the tabs 338 prevent the locking pin 334 from being removed from the aperture 332.

FIG. 3D is a cross-sectional view of a portion of the extension fitting assembly 300 coupled with the flyable fitting 210. To releasably secure the extension fitting assembly 300 with the flyable fitting 210, the maintenance operator positions the extension pipe 314 over the spigot 218 of the flyable fitting 210 and aligns the apertures 332 of the extension pipe 314 with the aperture 220 of the spigot 218. The maintenance operator then presses the button 336 on the locking pin 334 to retract the tabs 338. The maintenance operator positions the locking pin 334 through the aperture 332 on one side of the extension pipe 314, the aperture 220 in the spigot 218, and the aperture 332 on the other side of the extension pipe 314. The maintenance operator releases the button 336 to extend the tabs 338 and secure the locking pin 334 in position.

FIG. 3E illustrates the extension fitting assembly 300 assembled with the flyable fitting 210 at the second rotor hub 106 of the aircraft 100 of FIG. 1. In some examples, the extension fitting assembly 300 is not a flyable component. In other words, the extension fitting assembly 300 is removed before flight. The extension fitting assembly 300 can be removed from the aircraft 100 as a unit. The locking pin 334 facilitates a tool-free installation or detachment of the extension fitting assembly 300. In some examples, the extension pipe 300 includes a slot 340 for lanyard attachment of the locking pin 334 so that the locking pin 334 is kept in proximity with the extension fitting assembly 300 when the extension fitting assembly 300 is detached from the aircraft 100. In some examples, there is a flag or notice on or coupled to the extension fitting assembly 300 providing a reminder or other visual indication to remove the extension fitting assembly 300 before flight.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

From the foregoing, it will be appreciated that example systems, apparatus, articles of manufacture, and methods have been disclosed that enhance aircraft maintenance fall protection safety. As disclosed herein, portions of the aircraft maintenance fall protection systems may be installed on the aircraft permanently and are flyable. The flyable portions provide a non-intrusive installation that does not alter load paths or generate any new ones that could impact other qualified aircraft components. The flyable parts are designed to avoid corrosion and fretting and can handle the high vibratory environment of the rotor hub. The installation of the non-flyable components using a single quick release pin lowers the risks of introducing foreign object debris into the forward and after rotor shaft areas.

Systems, apparatus, articles of manufacture, and methods are disclosed for aircraft maintenance fall protection. Example 1 includes an example aircraft maintenance fall protection system that includes an anchor couplable to a rotor shaft of an aircraft, the anchor including a flyable fitting configured to be coupled to the rotor shaft during flight and an extension fitting assembly removably couplable to the flyable fitting, the extension fitting assembly to support a tether for a maintenance operator.

Example 2 includes the aircraft maintenance fall protection system of Example 1, wherein the flyable fitting includes a base to interface with the rotor shaft and a spigot to couple with the extension fitting assembly.

Example 3 includes the aircraft maintenance fall protection system of Example 2, further including a cover to be positioned over the base, the spigot to extend through the cover.

Example 4 includes the aircraft maintenance fall protection system of Examples 2 or 3, wherein the base is threadably couplable with an opening of the rotor shaft.

Example 5 includes the aircraft maintenance fall protection system of any of Examples 1-4, wherein the flyable fitting is concentric with a main rotor retaining nut of the rotor shaft.

Example 6 includes the aircraft maintenance fall protection system of any of Examples 1-5, wherein the extension fitting assembly includes an extension pipe and an anchorage fitting.

Example 7 includes the aircraft maintenance fall protection system of Example 6, wherein the anchorage fitting is rotatable about the extension pipe.

Example 8 includes the aircraft maintenance fall protection system of any of Examples 6 or 7, wherein the flyable fitting includes a base to interface with the rotor shaft and a spigot to couple with the extension fitting assembly, the extension pipe releasably couplable to the spigot with a self-locking pin.

Example 9 includes the aircraft maintenance fall protection system of any of Examples 6-8, wherein the anchor is a first anchor, the rotor shaft is a first rotor shaft, the flyable fitting is a first flyable fitting, and the extension fitting assembly is a first extension fitting assembly; the aircraft maintenance fall protection system including: a second anchor couplable to a second rotor shaft of the aircraft, the second anchor including: a second flyable fitting; and a second extension fitting assembly removably couplable to the second flyable fitting; and a static line that is securable to the anchorage fitting.

Example 10 includes the aircraft maintenance fall protection system of Example 9, further including a pulley movable along the static line.

Example 11 includes an apparatus that includes: a first extension fitting assembly removably couplable to a first flyable fitting on a rotor shaft of an aircraft; a second extension fitting assembly removably couplable to a second flyable fitting on the aircraft; a static line to extend between the first extension fitting assembly and the second extension fitting assembly; and a pulley movable along the static line, the pulley to be coupled to a harness to support a maintenance operator.

Example 12 includes the apparatus of Example 11, wherein the pulley is a first pulley, the harness is a first harness, and the maintenance operator is a first maintenance operator, the apparatus further including a second pulley movable along the static line simultaneously as the first pulley, the second pulley to be coupled to a second harness to support a second maintenance operator.

Example 13 includes the apparatus of Examples 11 or 12, wherein the first extension fitting assembly includes a first extension pipe and a first anchorage fitting rotatable about the first extension pipe, the second extension fitting assembly includes a second extension pipe and a second anchorage fitting rotatable about the second extension pipe, the static line to extend between the first anchorage fitting and the second anchorage fitting.

Example 14 includes the apparatus of any of Examples 11-13, further including a first self-locking pin to couple the first extension fitting with the first flyable fitting and a second self-locking pin to couple the second extension fitting with the second flyable fitting.

Example 15 includes an aircraft that includes: a rotor hub having a rotor shaft; a plurality of blades coupled to the rotor hub and rotatable about the rotor shaft; and a flyable fitting interfacing with the rotor shaft, the flyable fitting releasably couplable with an extension fitting assembly to support a maintenance fall protection system.

Example 16 includes the aircraft of Example 15, further including: a main rotor retaining nut; and an oil reservoir, the flyable fitting concentric with the main rotor retaining nut and the oil reservoir.

Example 17 includes the aircraft of Examples 15 or 16, wherein the rotor hub is a first rotor hub, the rotor shaft is a first rotor shaft, the plurality of blades are a first plurality of blades, the flyable fitting is a first flyable fitting, the extension fitting assembly is a first extension fitting assembly, the aircraft further including: a second rotor hub having a second rotor shaft; a second plurality of blades coupled to the second rotor hub and rotatable about the second rotor shaft; and a second flyable fitting interfacing with the second rotor shaft, the second flyable fitting releasably couplable with a second extension fitting assembly to support a maintenance fall protection system.

Example 18 includes the aircraft of any of Examples 15-17, wherein the flyable fitting is a first flyable fitting, the extension fitting assembly is a first extension fitting assembly, the aircraft further including: a tail boom; and a second flyable fitting interfacing with the tail boom, the second flyable fitting releasably couplable with a second extension fitting assembly to support a maintenance fall protection system.

Example 19 includes the aircraft of any of Examples 15-18, wherein the plurality of blades are rotatable while the extension fitting assembly and the maintenance fall protection system are coupled to the flyable fitting.

Example 20 includes the aircraft of any of Examples 15-19, wherein the aircraft is flyable with the flyable fitting.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An aircraft maintenance fall protection system comprising:
an anchor couplable to a rotor shaft of an aircraft, the anchor including:
a flyable fitting configured to be coupled to the rotor shaft during flight; and
an extension fitting assembly removably couplable to the flyable fitting, the extension fitting assembly to support a tether for a maintenance operator.

2. The aircraft maintenance fall protection system of claim 1, wherein the flyable fitting includes a base to interface with the rotor shaft and a spigot to couple with the extension fitting assembly.

3. The aircraft maintenance fall protection system of claim 2, further including a cover to be positioned over the base, the spigot to extend through the cover.

4. The aircraft maintenance fall protection system of claim 2, wherein the base is threadably couplable with an opening of the rotor shaft.

5. The aircraft maintenance fall protection system of claim 1, wherein the flyable fitting is concentric with a main rotor retaining nut of the rotor shaft.

6. The aircraft maintenance fall protection system of claim 1, wherein the extension fitting assembly includes an extension pipe and an anchorage fitting.

7. The aircraft maintenance fall protection system of claim 6, wherein the anchorage fitting is rotatable about the extension pipe.

8. The aircraft maintenance fall protection system of claim 6, wherein the flyable fitting includes a base to interface with the rotor shaft and a spigot to couple with the extension fitting assembly, the extension pipe releasably couplable to the spigot with a self-locking pin.

9. The aircraft maintenance fall protection system of claim 6, wherein the anchor is a first anchor, the rotor shaft is a first rotor shaft, the flyable fitting is a first flyable fitting, and the extension fitting assembly is a first extension fitting assembly; the aircraft maintenance fall protection system including:
a second anchor couplable to a second rotor shaft of the aircraft, the second anchor including:
a second flyable fitting; and
a second extension fitting assembly removably couplable to the second flyable fitting; and
a static line that is securable to the anchorage fitting.

10. The aircraft maintenance fall protection system of claim 9, further including a pulley movable along the static line.

11. An apparatus comprising:
a first extension fitting assembly removably couplable to a first flyable fitting on a rotor shaft of an aircraft;
a second extension fitting assembly removably couplable to a second flyable fitting on the aircraft;
a static line to extend between the first extension fitting assembly and the second extension fitting assembly; and
a pulley movable along the static line, the pulley to be coupled to a harness to support a maintenance operator.

12. The apparatus of claim 11, wherein the pulley is a first pulley, the harness is a first harness, and the maintenance operator is a first maintenance operator, the apparatus further including a second pulley movable along the static line simultaneously as the first pulley, the second pulley to be coupled to a second harness to support a second maintenance operator.

13. The apparatus of claim 11, wherein the first extension fitting assembly includes a first extension pipe and a first anchorage fitting rotatable about the first extension pipe, the second extension fitting assembly includes a second extension pipe and a second anchorage fitting rotatable about the second extension pipe, the static line to extend between the first anchorage fitting and the second anchorage fitting.

14. The apparatus of claim 11, further including a first self-locking pin to couple the first extension fitting with the first flyable fitting and a second self-locking pin to couple the second extension fitting with the second flyable fitting.

15. An aircraft comprising:
a rotor hub having a rotor shaft;
a plurality of blades coupled to the rotor hub and rotatable about the rotor shaft; and
a flyable fitting interfacing with the rotor shaft, the flyable fitting releasably couplable with an extension fitting assembly to support a maintenance fall protection system.

16. The aircraft of claim 15, further including:
a main rotor retaining nut; and
an oil reservoir, the flyable fitting concentric with the main rotor retaining nut and the oil reservoir.

17. The aircraft of claim 15, wherein the rotor hub is a first rotor hub, the rotor shaft is a first rotor shaft, the plurality of blades are a first plurality of blades, the flyable fitting is a first flyable fitting, the extension fitting assembly is a first extension fitting assembly, the aircraft further including:
a second rotor hub having a second rotor shaft;
a second plurality of blades coupled to the second rotor hub and rotatable about the second rotor shaft; and
a second flyable fitting interfacing with the second rotor shaft, the second flyable fitting releasably couplable with a second extension fitting assembly to support a maintenance fall protection system.

18. The aircraft of claim 15, wherein the flyable fitting is a first flyable fitting, the extension fitting assembly is a first extension fitting assembly, the aircraft further including:
a tail boom; and
a second flyable fitting interfacing with the tail boom, the second flyable fitting releasably couplable with a second extension fitting assembly to support a maintenance fall protection system.

19. The aircraft of claim 15, wherein the plurality of blades are rotatable while the extension fitting assembly and the maintenance fall protection system are coupled to the flyable fitting.

20. The aircraft of claim 15, wherein the aircraft is flyable with the flyable fitting.
